(19) United States
(12) Patent Application Publication
(10) Pub. No.: US 2017/0155536 A1
(43) Pub. Date: Jun. 1, 2017

(54) EMBEDDING DATA BASED ON ORTHOGONAL CODES

(71) Applicant: QUALCOMM Incorporated, San Diego, CA (US)

(72) Inventor: Bin XU, Cupertino, CA (US)

(21) Appl. No.: 15/357,711

(22) Filed: Nov. 21, 2016

Related U.S. Application Data
(60) Provisional application No. 62/261,799, filed on Dec. 1, 2015.
(60) Provisional application No. 62/261,295, filed on Nov. 30, 2015.

(51) Int. Cl. H04L 27/34; H04L 27/26

(52) U.S. Cl. CPC H04L 27/3405; H04L 27/2607; H04L 27/2627; H04L 27/345

(57) ABSTRACT

In an aspect of the disclosure, a method, a computer-readable medium, and an apparatus are provided. The apparatus may include a processing system configured to map a data set based on a modulation scheme, to modulate the mapped data set based on a set of codes, the set of codes being orthogonal to a portion of a frame, and to generate the frame comprising the modulated data set in the portion of the frame. The apparatus may include an interface configured to output the frame for transmission.

### CROSS-REFERENCE TO RELATED APPLICATION(S)

This application claims the benefit of U.S. Provisional Application Ser. No. 62/261,295, entitled “EMBEDDING DATA BASED ON ORTHOGONAL CODES” and filed on Nov. 30, 2015, and of U.S. Provisional Application Ser. No. 62/261,799, entitled “EMBEDDING DATA BASED ON ORTHOGONAL CODES” and filed on Dec. 1, 2015, which are expressly incorporated by reference herein in their entirety.

### BACKGROUND

Field

The present disclosure relates generally to communication systems, and more particularly, to embedding data within frames based on orthogonal codes (e.g., Hadamard codes).

Background

Communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

As communication networks become increasingly populated by wireless nodes, more efficient methods for transmitting information and reducing interference is needed. The disclosure below describes methods for more efficiently transmitting information and reducing interference.

In an aspect of the disclosure, a method, a computer-readable medium, and an apparatus are provided. The apparatus may include a processing system configured to map a data set based on a modulation scheme and to modulate the mapped data set based on a set of codes, the set of codes being orthogonal to a portion of a frame. The apparatus may include an interface configured to output the modulated data set for transmission.

In another aspect, an apparatus for wireless communication is provided. The apparatus includes means for mapping a data set based on a modulation scheme, means for modulating the mapped data set based on a set of codes, the set of codes being orthogonal to a portion of a frame, and means for outputting the modulated data set for transmission. In an aspect, the portion of the frame includes segments with redundancy. In another aspect, the segments with redundancy are associated with a long training field (LTF) symbol of the frame, a short training field (STF) symbol of the frame, or a cyclic prefix associated with data symbols of the frame. In another configuration, the means for modulating the mapped data set is configured to identify a subset of the set of codes in which a cross-correlation of the subset of the set of codes and the portion of the frame is zero and to modulate the mapped data set based on the subset of the set of codes. In another aspect, the set of codes comprises Hadamard codes. In another aspect, the data set is mapped, based on a type of quadrature amplitude modulation (QAM), to at least one QAM symbol. In another configuration, the apparatus includes means for obtaining one or more data packets from at least one wireless node and means for generating the data set based on the received one or more data packets. In another aspect, the data set includes a pathloss and a device identifier associated with the at least one wireless node. In another configuration, the apparatus includes comprises means for generating the frame and means for outputting the frame for broadcasting. In another aspect, the modulated data is added to the portion of the frame based on a power factor. In yet another aspect, the power factor is equal to or less than 0 decibels.

In another aspect of the disclosure, a computer-readable medium is provided. The computer-readable medium comprises codes executable by an apparatus to map a data set based on a modulation scheme, to modulate the mapped data set based on a set of codes, the set of codes being orthogonal to a portion of a frame, and to output the modulated data set for transmission.

In another aspect of the disclosure, a method, a computer-readable medium, and an apparatus are provided. The apparatus may comprise an interface configured to obtain a frame from a second apparatus, wherein the frame comprises a portion having data encoded based on a set of codes, and wherein the set of codes is orthogonal to the portion of the frame. The apparatus may comprise a processing system configured to decode the encoded data. In one configuration, the processing system is configured to decode the encoded data by demodulating the encoded data within the portion of the frame based on the set of codes and by demapping the demodulated data to obtain decoded data. In an aspect, the portion of the frame includes segments with redundancy. In another aspect, the segments with redundancy are associated with a long training field (LTF) symbol of the frame, or a short training field (STF) symbol of the frame, or a cyclic prefix associated with data symbols of the frame. In another aspect, the set of codes comprises Hadamard codes. In another aspect, the decoded data includes interference data comprising a pathloss and a device identifier. In another configuration, the interface is further configured to obtain additional frames from other apparatuses, wherein each of the additional frames includes additional interference data encoded based on the set of codes. In this configuration, the processing system is further configured to decode the additional interference data from the additional frames and to generate an interference matrix based on the interference data and the decoded additional interference data, wherein the interference matrix comprises one or more pathloss values, and each of the one or more pathloss values is associated with a transmitter identifier and a receiver identifier. In another configuration, the processing system is further configured to determine whether to transmit data to a third apparatus based on the generated interference matrix, and wherein the interface is further configured to output the data for transmission based on the determination. In another configuration, the processing system determines whether to transmit data by determining an amount of interference at the third apparatus based on the generated interference matrix, by identifying a set of transmission parameters for transmitting the data to the apparatus, and by calculating an expected signal quality at the third apparatus based on the determined amount of interference and the identified set of transmission parameters, wherein the determination of whether to transmit the data is based on the expected signal quality at the apparatus, and wherein the data is outputted based on the expected signal quality at the third apparatus.

In another aspect of the disclosure, a method for wireless communication by a first wireless node is provided. The method comprises obtaining a frame from a second wireless node, wherein the frame comprises a portion having data encoded based on a set of codes, and wherein the set of codes is orthogonal to the portion of the frame. The method comprises decoding the encoded data. In one configuration, the decoding the encoded data comprises demodulating the encoded data within the portion of the frame based on the set of codes and demapping the demodulated data to obtain decoded data. In an aspect, the portion of the frame includes segments with redundancy. In another aspect, the segments with redundancy are associated with a long training field (LTF) symbol of the frame, or a short training field (STF) symbol of the frame, or a cyclic prefix associated with data symbols of the frame. In another aspect, the set of codes comprises Hadamard codes. In another aspect, the decoded data includes interference data comprising a pathloss and a device identifier. In another configuration, the method further comprises obtaining additional frames from other apparatuses, wherein each of the additional frames includes additional interference data encoded based on the set of codes, decoding the additional interference data from the additional frames, and generating an interference matrix based on the interference data and the decoded additional interference data, wherein the interference matrix comprises one or more pathloss values, and each of the one or more pathloss values is associated with a transmitter identifier and a receiver identifier. In another configuration, the method further comprises determining whether to transmit data to a third apparatus based on the generated interference matrix and transmitting the data based on the determination. In another configuration, the determining whether to transmit data comprises determining an amount of interference at the third apparatus based on the generated interference matrix, identifying a set of transmission parameters for transmitting the data to the apparatus, and calculating an expected signal quality at the third apparatus based on the determined amount of interference and the identified set of transmission parameters, wherein the determination of whether to transmit the data is based on the expected signal quality at the apparatus, and wherein the data is outputted based on the expected signal quality at the third apparatus.

In another aspect of the disclosure, an apparatus for wireless communication. The apparatus comprises means for obtaining a frame from a second apparatus, wherein the frame comprises a portion having data encoded based on a set of codes, and wherein the set of codes is orthogonal to the portion of the frame and means for decoding the encoded data. In another configuration, the means for decoding the encoded data is configured to demodulate the encoded data within the portion of the frame based on the set of codes and to demap the demodulated data to obtain decoded data. In an aspect, the portion of the frame includes segments with redundancy. In another aspect, the segments with redundancy are associated with a long training field (LTF) symbol of the frame, or a short training field (STF) symbol of the frame, or a cyclic prefix associated with data symbols of the frame. In another aspect, the set of codes comprises Hadamard codes. In another aspect, the decoded data includes interference data comprising a pathloss and a device identifier. In another configuration, the apparatus comprises means for obtaining additional frames from other apparatuses, wherein each of the additional frames includes additional interference data encoded based on the set of codes, means for decoding the additional interference data from the additional frames, and means for generating an interference matrix based on the interference data and the decoded additional interference data, wherein the interference matrix comprises one or more pathloss values, and each of the one or more pathloss values is associated with a transmitter identifier and a receiver identifier. In another configuration, the apparatus comprises means for determining whether to transmit data to a third apparatus based on the generated interference matrix and means for transmitting the data based on the determination. In another configuration, the means for determining whether to transmit data is configured to determine an amount of interference at the third apparatus based on the generated interference matrix, to identify a set of transmission parameters for transmitting the data to the apparatus, and to calculate an expected signal quality at the third apparatus based on the determined amount of interference and the identified set of transmission parameters, wherein the determination of whether to transmit the data is based on the expected signal quality at the apparatus.

In another aspect of the disclosure, a computer-readable medium is provided. The computer-readable medium comprises codes executable by an apparatus to obtain a frame from a wireless node, wherein the frame comprises a portion having data encoded based on a set of codes, and wherein the set of codes is orthogonal to the portion of the frame and to decode the encoded data.

In another aspect of the disclosure, a station for wireless communication is provided. The station comprises an interface configured to obtain a frame from a second station, wherein the frame comprises a portion having data encoded based on a set of codes, and wherein the set of codes is orthogonal to the portion of the frame. The station comprises a processing system configured to decode the encoded data

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a diagram of an example wireless communications network, in accordance with certain aspects of the present disclosure.

FIG. 2 illustrates a block diagram of an example access point (AP) and user terminals (UTs), in accordance with certain aspects of the present disclosure.

FIG. 3 illustrates a diagram of OBSSs with diminished network throughput.

FIG. 4 illustrates a method of embedding data using a physical layer protocol with orthogonal codes.

FIGS. 5A-C are diagrams that illustrate Walsh-Hadamard codes being orthogonal to various segments of an IEEE 802.11 PPDU.

FIG. 6A illustrates a diagram of an L-LTF projection onto Walsh-Hadamard codes.

FIG. 6B illustrates a diagram of an L-LTF projection onto Walsh-Hadamard codes with orthogonal modulation with embedded data.

FIG. 6C is a diagram of a power ratio between PPDU symbols and the modulated QAM symbols.

FIG. 7 is a block diagram of a method of performing orthogonal modulating using preambles and/or a cyclic prefix.

FIG. 8 illustrates a table of data rates by orthogonal coding.

FIG. 9 shows an example functional block diagram of a wireless device configured to transmit and receive information on a data channel.

FIG. 10 is a flowchart of an example method of transmitting data on an extra data channel for wireless communication.

FIG. 11 illustrates exemplary means capable of performing the operations set forth in FIG. 10.

FIG. 12 is a flowchart of an example method of receiving data on an extra data channel for wireless communication.

FIG. 13 illustrates exemplary means capable of performing the operations set forth in FIG. 12.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station (MS), a remote station, a remote terminal, a user terminal (UT), a user agent, a user device, user equipment (UE), a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

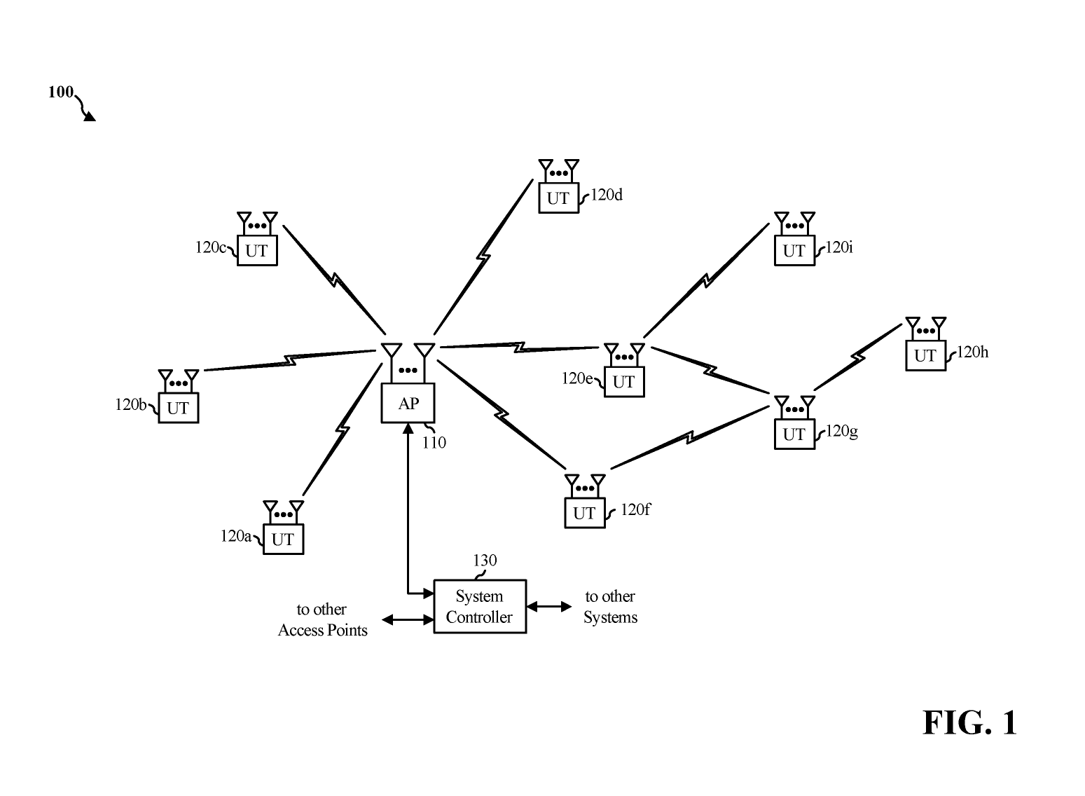

FIG. 1 illustrates a multiple-access multiple-input multiple-output (MIMO) system 100 with access points and user terminals in which aspects of the present disclosure may be practiced. For example, one or more user terminals 120 may signal capabilities (e.g., to access point 110) using the techniques provided herein.

For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless node, a wireless node, or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an AP 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The access point 110 and user terminals 120 employ multiple transmit and multiple receive antennas for data transmission on the downlink and uplink. For downlink MIMO transmissions, Nₐₚ antennas of the access point 110 represent the multiple-input (MI) portion of MIMO, while a set of K user terminals represent the multiple-output (MO) portion of MIMO. Conversely, for uplink MIMO transmissions, the set of K user terminals represent the MI portion, while the Nₐₚ antennas of the access point 110 represent the MO portion. For pure SDMA, it is desired to have Nₐₚ≧k≧1 if the data symbol streams for the K user terminals are not multiplexed in code, frequency or time by some means. K may be greater than Nₐₚ if the data symbol streams can be multiplexed using TDMA technique, different code channels with CDMA, disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

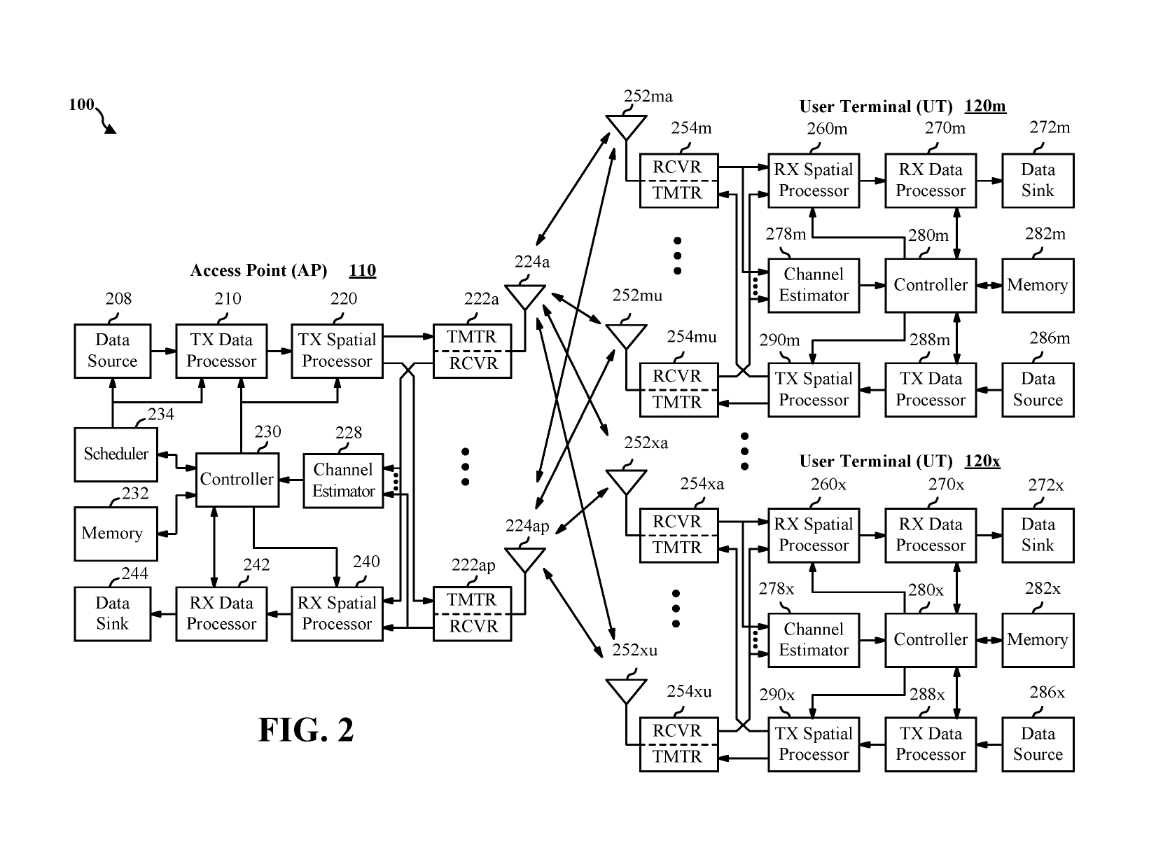

FIG. 2 illustrates a block diagram of access point 110 and two user terminals 120m and 120x in MIMO system 100 that may be examples of the access point 110 and user terminals 120 described above with reference to FIG. 1 and capable of performing the techniques described herein. The various processors shown in FIG. 2 may be configured to perform (or direct a device to perform) various methods described herein.

The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink. For SDMA transmissions, Nᵤₚ user terminals simultaneously transmit on the uplink, while Nan user terminals are simultaneously transmitted to on the downlink by the access point 110. Nᵤₚ may or may not be equal to N_{dn}, and Nᵤₚ and N_{dn} may be static values or can change for each scheduling interval. The beam-steering or some other spatial processing technique may be used at the access point and user terminal.

On the uplink, at each user terminal 120 selected for uplink transmission, a transmit (TX) data processor 288 receives traffic data from a data source 286 and control data from a controller 280. The controller 280 may be coupled with a memory 282. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nᵤₚ user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nᵤₚ user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nᵤₚ recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing. The controller 230 may be coupled with a memory 232.

On the downlink, at access point 110, a TX data processor 210 receives traffic data from a data source 208 for N_{dn} user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides N_{dn} downlink data symbol streams for the N_{dn} user terminals. A TX spatial processor 220 performs spatial processing (such as a precoding or beamforming, as described in the present disclosure) on the N_{dn} downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal. The decoded data for each user terminal may be provided to a data sink 272 for storage and/or a controller 280 for further processing.

At each user terminal 120, a channel estimator 278 estimates the downlink channel response and provides downlink channel estimates, which may include channel gain estimates, SNR estimates, noise variance and so on. Similarly, at access point 110, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

As communication networks become increasingly populated by wireless nodes, more efficient methods for transmitting information and reducing interference is needed. In WLAN systems, for example, interference among overlapping BSSs (OBSSs) may diminish throughput due to clear channel assessment (CCA) based carrier sense multiple access with collision avoidance (CSMA/CA) protocol, which is fundamental to communication systems compliant with the IEEE 802.11 standard. That is, when one wireless node detects another wireless node (e.g., in an OBSS) transmitting in the same medium, the wireless node may defer communications to the other wireless node. When multiple BSSs overlap, wireless nodes may become starved of transmit opportunities. To increase medium reuse, an inter-BSS interference matrix may be used to determine when a certain amount of interference is tolerable and additional transmissions are feasible.

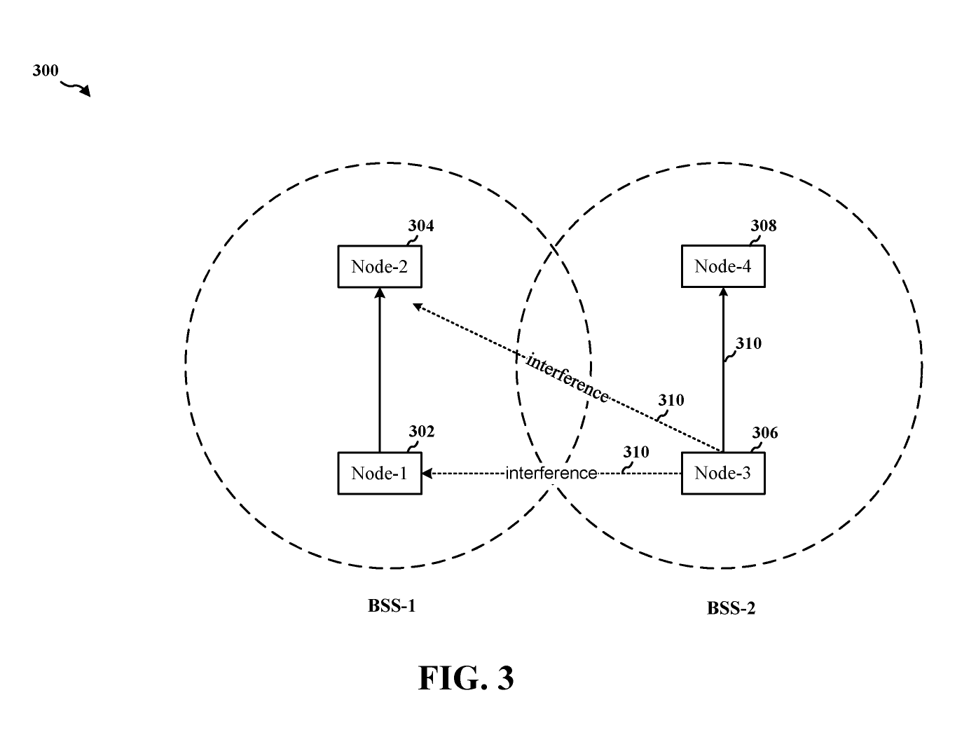

FIG. 3 illustrates a diagram 300 of OBSSs with diminished network throughput. Referring to FIG. 3, BSS 1 overlaps with BSS 2. BSS 1 includes a first wireless node 302 and a second wireless node 304. BSS 2 includes a third wireless node 306 and a fourth wireless node 308. The third wireless node 306 may send a transmission 310 to the fourth wireless node 308. The wireless nodes may correspond to an AP or a station (STA)/UT. Because the BSS 2 overlaps with BSS 1, however, the transmission 310 originating from BSS 2 may also be received by the second wireless node 304 and/or the first wireless node 302 as interference in BSS 1.

Upon detecting the transmission 310, the first and second wireless nodes 302, 304 may determine that the transmission 310 is occurring on the channel (and/or frequency) that either the first wireless node 302 or the second wireless node 304 intended to transmit. Based on the detected transmission, the first and second wireless nodes 302, 304 may refrain from transmitting on the particular channel on which the transmission 310 was detected. For example, the first wireless node 302 may determine that an energy detection level is above a threshold based on the transmission 310, which indicates that the channel is busy. As such, the first wireless node 302 may refrain from transmitting to the second wireless node 304. Similarly, the second wireless node 304 may also refrain from transmitting on the channel due to the detected interference from the transmission 310.

As shown in FIG. 3, interference from OBSSs may limit throughput among wireless nodes, and a need exists to increase medium reuse. One method of increasing reuse is to enable an exchange of interference values among wireless nodes in OBSSs such that devices may transmit data even when interference is detected if the data may be received by the intended recipient above a certain signal-to-interference ratio (SINR) threshold or signal-to-noise ratio (SNR) threshold (or any other signal quality threshold). In one aspect, signaling in the medium access control (MAC) layer may be used to indicate interference at each wireless node. For example, a new MAC management frame dedicated to exchanging interference values among devices in OBSSs may be used. Such an implementation may be standardized but the implementation introduces a new frame for interference signaling, which may cause bandwidth loss (e.g., 20-30%).

In another aspect, upper-layer software may be used to exchange interference values. For example, software in layer-3 (e.g., the network layer) and above (e.g., the transport layer, the session layer, etc.) may be implemented in network controllers to enable the exchange of interference information. However, upper-layer software implementation may be difficult to standardize because the IEEE 802.11 standard may only contain physical and MAC layer requirements. The software may be vendor-proprietary, and different wireless nodes may not process the interference information consistently. Furthermore, upper-layer software solutions, like the MAC layer solution, may introduce bandwidth loss.

A third method, as further discussed below, is a physical layer protocol for exchanging interference information among OBSSs. A physical layer solution may be standardized, be more efficient, and incur no bandwidth loss.

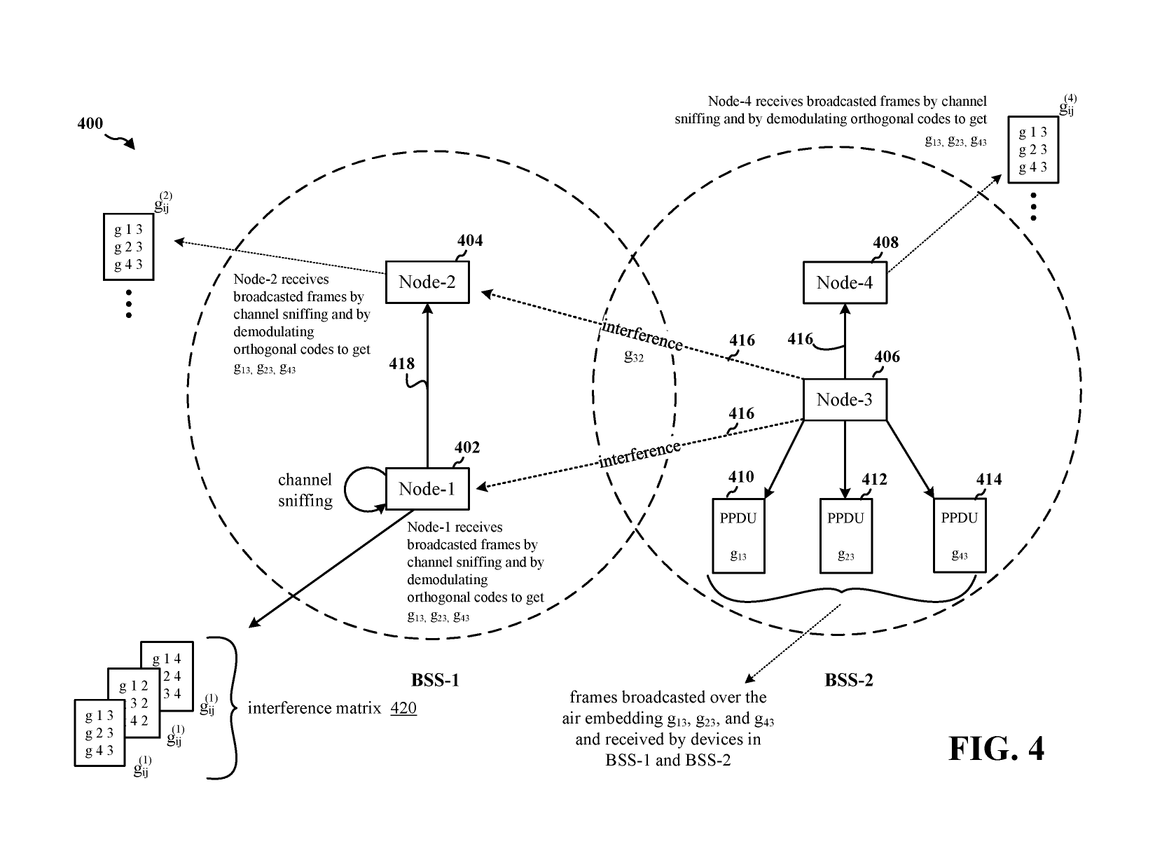

FIG. 4 illustrates a method 400 of embedding data using a physical layer protocol with orthogonal codes. Referring to FIG. 4, BSS 1 includes a first wireless node 402 and a second wireless node 404. BSS 2 includes a third wireless node 406 and a fourth wireless node 408. Because BSS 1 overlaps with BSS 2, each of the wireless nodes within each BSS may receive transmissions from wireless nodes from the same BSS and from OBSSs. For example, the third wireless node 406 may receive transmissions from the first, second, and fourth wireless nodes 402, 404, 408 due to normal WLAN traffic, for example. Based on the received transmissions, the third wireless node 406 may determine a pathloss, denoted by gᵢⱼ, to each of the first, second, and fourth wireless nodes 402, 404, 408. Referring to the pathloss notations, g may indicate a pathloss in dB, i may refer to the transmitter node, j may refer to the destination node, and k may refer to the perceiving node perceiving the pathloss. As such, based on the received transmissions, the third wireless node 406 may calculate g₁₃, which corresponds to the pathloss between the first wireless node 402 and the third wireless node 406, g₂₃, which corresponds to the pathloss between the second wireless node 404 and the third wireless node 406, and g₄₃, which corresponds to the pathloss between the fourth wireless node 408 and the third wireless node 406. Other wireless nodes may also generate similar pathloss values.

The third wireless node 406 may generate interference information that includes the pathlosses, g₁₃, g₂₃, g₄₃. Each pathloss g may be presented by 7 bits (or some other number of bits). The interference information may also indicate for each pathloss, identifiers associated with the transmitter and the receiver of the frame or packet used to determine the pathloss. For example, the interference information may include g₁₃ and identifiers for the first wireless node 402 and the third wireless node 406. In an aspect, 9 bits (or some other number of bits) may be used for each transmitter identifier and each receiver identifier for a total of 18 bits to represent both identifiers. In another aspect, the transmitter and receiver identifiers may be MAC addresses associated with the transmitter and receiver. In another aspect, the identifiers may be partial MAC addresses (or partial association identifiers (AIDs)). In another aspect, the pathloss and associated transmitter and receiver identifiers may be elements within a matrix.

After generating the interference information, the third wireless node 406 may perform quadrature amplitude modulation (QAM) mapping to map the interference information (or matrix elements) onto QAM symbols. Different types of QAM may be used, such as 4 QAM (or QPSK), 16 QAM, 32 QAM, etc. After mapping the interference information, the third wireless node 406 may modulate the QAM symbols onto a set of orthogonal (or asymmetrical) codes by spreading and applying a spectrum mask. The mapped QAM symbols may be modulated within a portion of a frame. The portion may be associated with a long training field (LTF) symbol, a short training field (STF) symbol, and/or cyclic prefixes (CPs) associated with data symbols in the frame or with the LTF symbol.

The LTF symbol, STF symbol, and cyclic prefixes may include segments with redundancy (or segments with the same data). For example, a legacy STF symbol may have a waveform in which there are 10 repeating segments, each being 0.8 μs in length. A legacy LTF symbol may have another waveform with 2 repeating segments, each being 3.2 μs in length. The legacy LTF may also have a 1.6 μs cyclic prefix. A CP in a data symbol may be 0.8 μs or 0.4 μs. The data symbol may be 3.2 μs in length. In these examples, segments with redundancy may refer to one or more repeating segments in the STF symbol, one or more repeating segments in the LTF symbol, and/or one or more CPs in data symbols, or the CP in the LTF symbol.

Although the above mentioned examples refer to legacy LTF and STF, the LTF and STF symbols may also refer to high throughput (HT) LTF/STF, and/or very high throughput (VHT) LTF/STF. Further, LTF, STF, and CP may refer to the LTF, STF, and CPs of future IEEE 802.11 standards, and the same principle of segments with redundancy may apply to different variations of LTF, STF, and/or CPs.

The third wireless node 406 may modulate the mapped QAM symbols based on a set of codes that is orthogonal to part of an LTF symbol, part of an STF symbol, and/or one or more short or long CPs. An example of such a set of codes is Walsh Hadamard codes. Other codes that similar to or are variant of the Hadamard codes may also be used. The set of codes is orthogonal to a part of an LTF symbol, a part of an STF symbol, or a CP because the dot product (or cross-correlation) of at least a portion of the codes and the part of the LTF symbol, the part of the STF symbol, and/or the CP is equal to zero.

The third wireless node 406 may set the modulation power to be low relative to a typical power used to transmit LTF, STF, and/or data symbols. For example, the third wireless node 406 may modulate the mapped QAM symbols with −24 decibels (dB) below the typical power (e.g., 20 dB) used to transmit the LTF, STF, and/or data symbols. That is, the mapped QAM symbols containing the interference information (e.g., g₁₃, g₂₃, g₄₃) may be modulated onto the waveform of a first frame 410, a second frame 412, and/or a third frame 414, respectively, as shown in FIG. 4. The third wireless node 406 may use a first transmit power to transmit typical LTF, STF, and data symbol information and use a second transmit power, which is less than the first transmit power, to transmit the mapped QAM symbols containing the interference information. By using low power modulation, processing of the channel estimation data within the LTF and STF symbols is not affected. The low power modulation also enables compatibility with legacy nodes that may not support this physical layer protocol (e.g., if APs are equipped with this protocol but STAs are not, multiple transmission traffic may only be enabled for downlink transmissions). The third wireless node 406 may broadcast the first, second, and third frames 410, 412, 414.

Subsequently, the first, second, and fourth wireless nodes 402, 404, 408 may each receive, through channel sniffing or channel listening, the first, second, and third frames 410, 412, 414 containing the interference information. The first wireless node 402, for example, may decode the interference information in the first frame 410 by demodulating the encoded data using the set of codes (e.g., Hadamard codes) by performing equalization and de-spreading to obtain the mapped QAM symbols containing the interference information. Next, the first wireless node 402 may demap the demodulated data to convert the QAM symbols to obtain the decoded data that corresponds to the interference information. The first wireless node 402 may store the pathloss values and the associated identifiers (e.g., transmitter MAC address and receiver MAC address) transmitted by the third wireless node 406. The interference information from the third wireless node 406 may be denoted by gᵢⱼ^{(k)}, where k corresponds to a perceiving node, i corresponds to the transmitting node, and j corresponds to the receiving node. More specifically, the interference information stored by the first wireless node 402 from the third wireless node 406 may be denoted g₁₃⁽¹⁾, g₂₃⁽¹⁾, g₄₃⁽¹³⁾. Other nodes (e.g., the second wireless node 404 and the fourth wireless node 408) may transmit frames that also contain interference information. The first wireless node 402 may also decode the frames from the other nodes to generate an interference matrix 420. That is, each of the broadcasted frames from different wireless nodes may populate elements in the interference matrix 420. The interference matrix 420 may be a three dimensional interference matrix generated from multiple two dimensional matrices. Each two dimensional matrix be associated with one receiver node. And the matrix may include pathloss information based on packets received by the receiver node from different transmitters. In addition to the pathloss information, the two dimension matrix may also include, for each pathloss, identifiers associated with transmitter and the receiver. Other wireless nodes (e.g., the second, third, and fourth wireless nodes 404, 406, 408) may also receive frames from other devices within the BSS and OBSSs and generate a respective interference matrix.

Depending on the number of OBSSs (N) and the number of nodes per OBSS (L), the complexity of the interference matrix may increase rapidly (e.g., matrix complexity) and may be determined by the following equation:

Matrix Complexity=NL[4(N−1)(L−1)+(N+1)]−2N

For example, in the case of 2 OBSSs (each with 1 AP and 2 STAs), the matrix complexity (or number of matrix elements) may be 62 (for N=2, L=3). In the case of 3 OBSSs (each with 1 AP and 3 STAs), the matrix complexity may be 330 matrix elements (for N=3, L=4). In the case of 4 OBSSs (each with 1 AP and 5 STAs), the matrix complexity may be 1552 matrix elements (for N=4, L=6).

Referring to FIG. 4, the first wireless node 402 may have a first transmission 418 to send to the second wireless node 404. The third wireless node 406, however, may be sending the fourth wireless node 408 a second transmission 416 on the same channel or frequency. The first wireless node 402 may detect the second transmission 416 as interference. The second transmission 416 may also interfere with the first transmission from the first wireless node 402 to the second wireless node 404. Instead of deferring to the third wireless node 406 as a matter of course, however, the first wireless node may calculate the SINR (or some other signal quality metric) of the first transmission 418 at the second wireless node 404 using the interference matrix 420. The interference matrix 420 may include pathloss and associated identifiers populated based on broadcasted interference information. The first wireless node 402 may determine that the pathloss between the first wireless node 402 and the second wireless node 404 is g12 based on the interference matrix 420. The first wireless node 402 may also estimate the interference at the second wireless node 404 as a result of the second transmission 416 based on g32 indicated in the interference matrix 420. Based on the known pathloss and the estimated interference at the second wireless node 404, the first wireless node 402 may estimate an expected SINR at the second wireless node 404. If the expected SINR is equal to or greater than a threshold, the first wireless node 402 may send the first transmission 418 to the second wireless node 404 despite the medium being in use. But if the expected SINR is less than the threshold, then the first wireless node 402 may refrain from sending the first transmission 418.

Although this example uses orthogonal coding for purposes for transmitting interference information, any other types of information may also be transmitted using the protocol as described above. The physical layer protocol using orthogonal coding adds a channel without creating any additional bandwidth loss, and any kind of data may be transmitted on the channel.

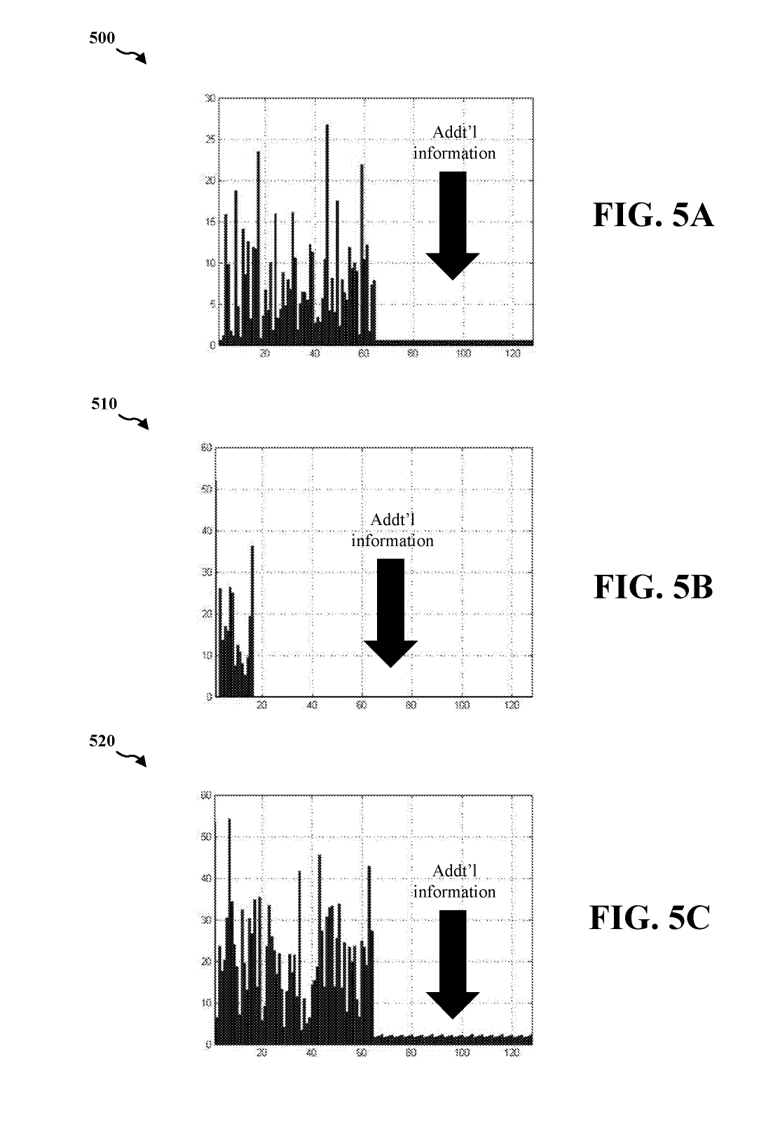

FIGS. 5A-C are diagrams 500, 510, 520 that illustrate Walsh-Hadamard codes being orthogonal to various segments of an IEEE 802.11 PPDU. In FIGS. 5A-C, the x-axis represents code indices and the y-axis represents energy. Referring to FIG. 5A, a projection of a legacy LTF symbol to code indices 64-127 of spreading factor 128 results in all zeros. As such, code indices 64-127 may be used to transmit additional information using signal characteristics of orthogonality. Extra information (or data) may be encoded into QAM symbols that are modulated by the Walsh-Hadamard codes at low energy compared to the legacy LTFs. In this way, after the orthogonal codes are added to the PPDU, signal processing at the receiver node is not affected for legacy nodes. For nodes compliant with this protocol, the receiver node may perform extra signal processing steps to demodulate the segments by de-spreading with orthogonal Walsh-Hadamard codes and demapping the QAM symbols carrying the data. As discussed in FIG. 4, if the data is interference information, an interference matrix may be generated using the data.

Similarly, FIG. 5B illustrates that segments of an legacy STF symbol that are also orthogonal to some of the Walsh-Hadamard codes. For example, code indices 20-127 may be used to transmit additional information besides the STF information. FIG. 5C illustrates that the cyclic prefix of data symbols (which may include the signal field) that is also orthogonal to some of the Walsh-Hadamard codes. In FIG. 5C, code indices 70-127, for example, may be used to transmit additional information. Other code indices ranges may also be used.

Although FIGS. 5A-C depict legacy STF and LTF, the orthogonality properties are also true with respect to other types of STF such as HT-STF and VHT-STF and to other types of LTF such as HT-LTF and VHT-LTF.

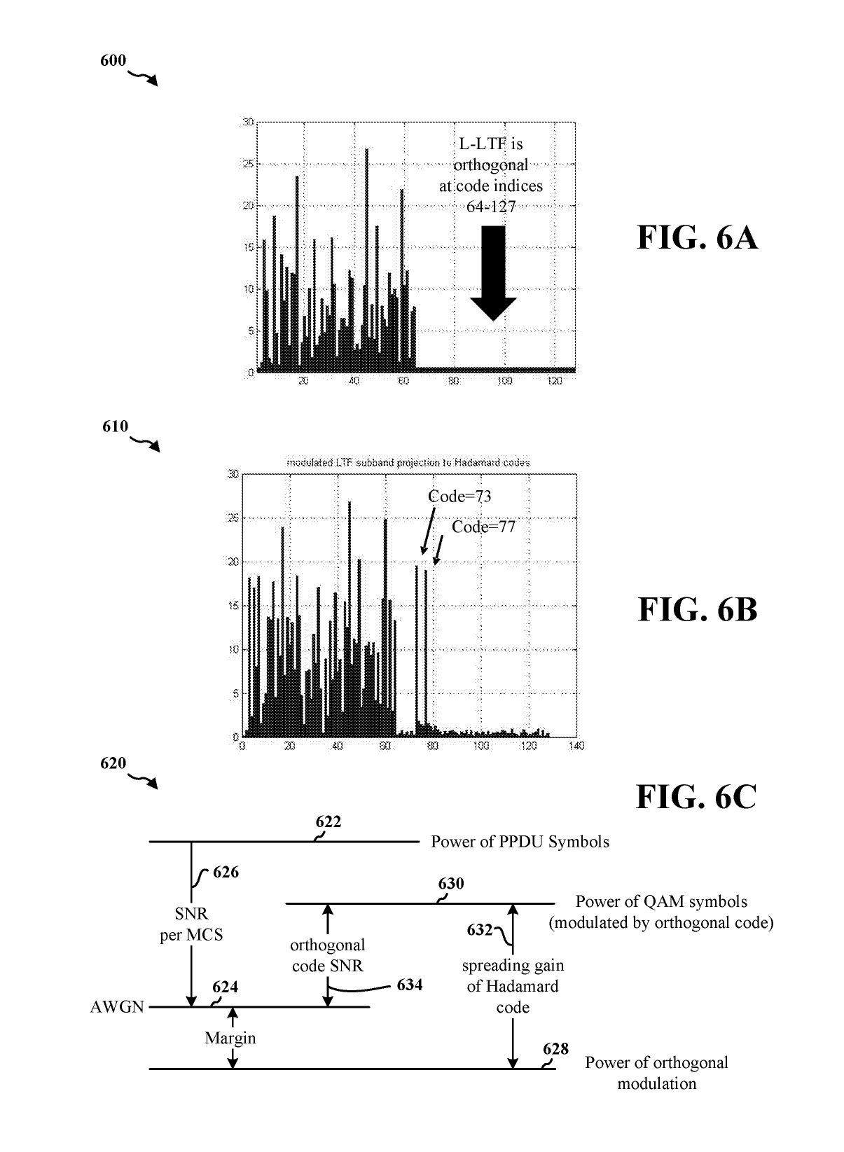

FIG. 6A illustrates a diagram 600 of an L-LTF projection onto Walsh-Hadamard codes. As shown in FIG. 6A, a segment of the L-LTF symbol is orthogonal to code indices 64-127 of the Walsh-Hadamard codes (with a spreading factor of 128), and therefore, information may be carried on code indices 64-127.

FIG. 6B illustrates a diagram 610 of an L-LTF projection onto Walsh-Hadamard codes with orthogonal modulation that includes embedded data. As shown in FIG. 6B, data has been modulated onto code index 73 and code index 77. For example, code indices 73 and 77 may have BPSK modulated data added. By adding the data at low power, the L-LTF may still be decoded by legacy devices.

FIG. 6C is a diagram 620 of a power ratio between PPDU symbols and the modulated QAM symbols. A first line 622 represents a power level of PPDU symbols. A second line 624 represents a power level of an additive white Gaussian noise (AWGN) or a thermal noise. A first difference 626 between the first line 622 and the second line 624 represents a recommended or required SNR at a particular MCS. In an aspect, the AWGN may be used to compute the SNR, which may be used to determine the MCS, which corresponds to a data rate. As such, based on the AWGN and the available PPDU symbol power, a data rate may be determined. A third line 628 represents a power used for orthogonal modulation. Further, as shown in FIG. 6C, the power used for orthogonal modulation is less than the AWGN and backed off by a margin (or a back-off value). In an aspect, the margin (or back-off) may be simulated by time domain correction (e.g., channel estimation, timing offset, frequency offset, temperature offset, and other corrections) and block error rate performance per MCS. As such, the additive orthogonal modulation does not impact normal WLAN packet performance. Further, because Hadamard codes have a spreading gain, the spreading gain may yield a good SNR for QAM symbols, obtained after demodulating the data based on the orthogonal codes. A fourth line 630 depicts the power level of the demodulated QAM symbols A second difference between the fourth line 630 and the third line 628 may represent the spreading gain of the Hadamard code. The power of the PPDU symbols need not affect an orthogonal code SNR 634, represented as a difference between the fourth line 630 and the second line 624, because the Hadamard codes are orthogonal to the PPDU symbols. The orthogonal code SNR 634 may be determined based on a spreading gain (e.g., SF=128 may have a spreading gain of 21 dB). As such, the power of the PPDU symbols are zero with respect to the QAM symbols. As such, the power from the PPDU symbols do not contribute to the orthogonal code SNR only to the AWGN as white noise. Referring again to FIG. 6C, various data rates of orthogonal modulation may be designed by specifying an orthogonal code SNR.

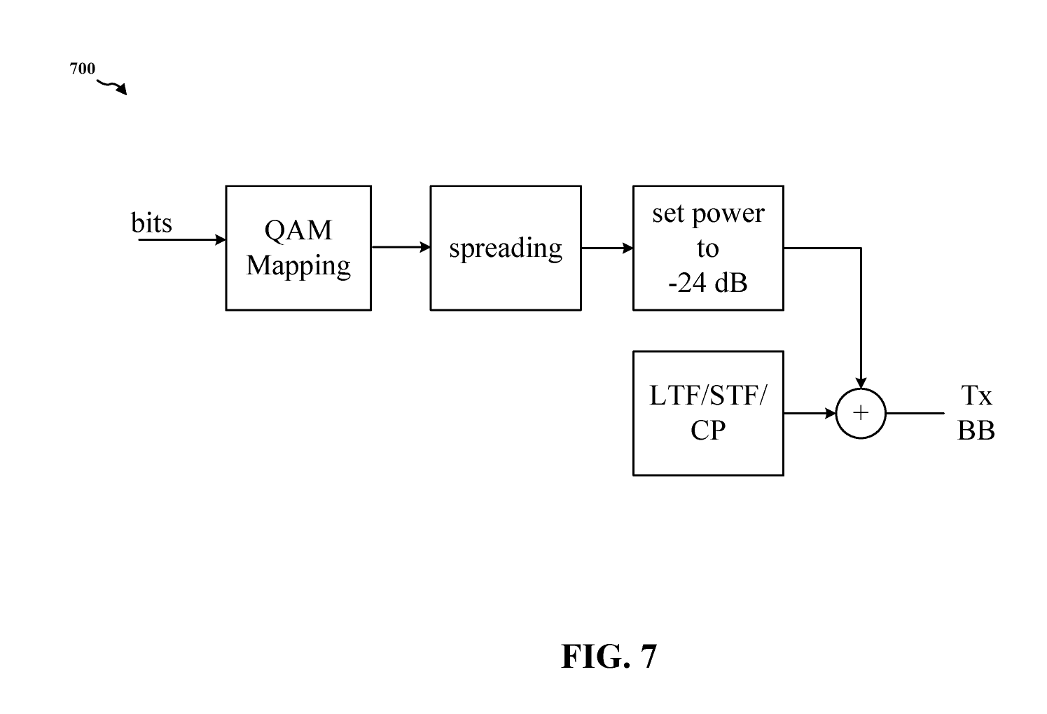

FIG. 7 is a block diagram 700 of a method of performing orthogonal modulating using preambles (e.g., LTF, STF) and/or a cyclic prefix. Referring to FIG. 7, a set of bits is mapped using a type of QAM. The mapped QAM symbols are then spread and subjected to a spectrum mask according to a set of orthogonal codes such as Hadamard codes. The data may be modulated with a power of −24 dB less than the typical power used to transmit the a packet. In an aspect, −24 dB may be determined based on the following equation: −24 dB=−(SNR 20 dB for legacy packets MCS 7)+(additional −4 dB back-off). A different power may also be used for the modulation. The modulated data may be combined with LTF symbols, STF symbols, and/or cyclic prefixes associated with data symbols for transmission. In an aspect, the spectrum mask may be applied after spreading to a full bandwidth, which may be equal to a chip rate. In another aspect, the power setting may be higher or lower depending on the actual MCS number of the frame. For example, for MCS 0, the higher bound may be −6 dB, and for MCS 9, the lower bound may be −34 dB.

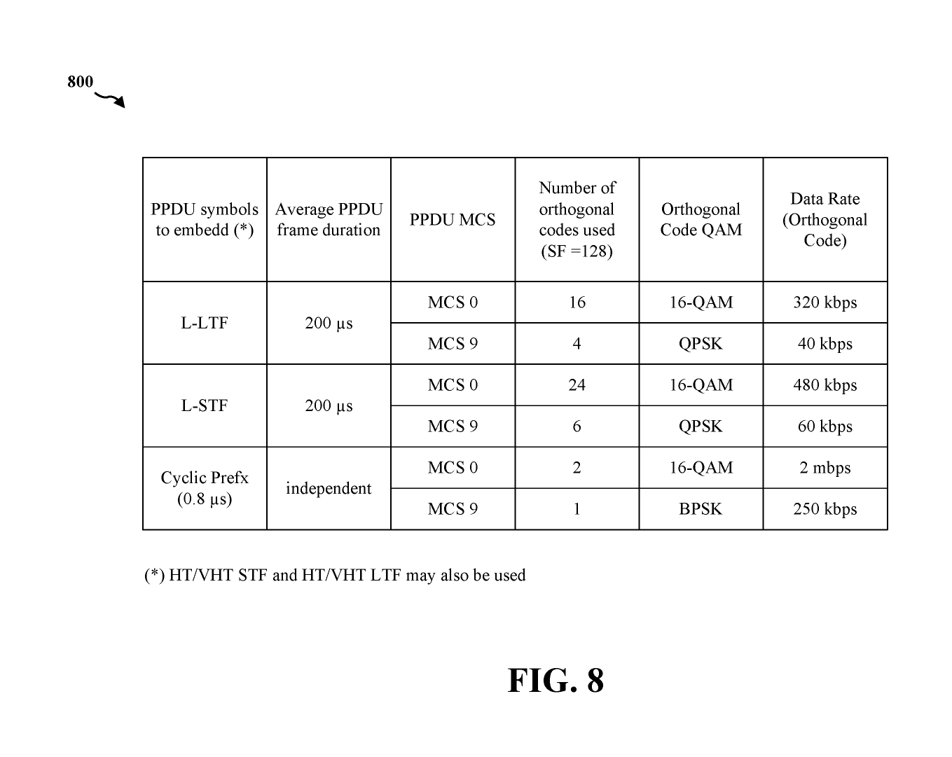

FIG. 8 illustrates a table 800 of data rates by orthogonal coding. Although previous examples have used orthogonal coding to exchange interference information without bandwidth loss, the same orthogonal coding protocol may be used to create a zero bandwidth loss data channel to transmit to other types of data. For example, the orthogonal coding protocol may be used as an always-on data channel for WLAN control signals. In another aspect, the protocol may be used to transmit uplink and/or downlink trigger frames (or trigger frame information) in future IEEE 802.11 standards for OFDMA and MU-MIMO in order to improve uplink bandwidth efficiency. The table 800 illustrates different data rates that can be supported by the channel depending on where the data is embedded (e.g., LTF, STF, cyclic prefix), the average PPDU frame duration, a PPDU MCS, the number of orthogonal codes used, and the type of QAM selected.

In sum, a physical layer framework may be used to provide an extra data channel that increases transport capacity without introducing additional bandwidth loss. In one aspect, the additional capacity may be used to transmit interference data to improve DFS, TPC, CCA, and OBSS. In another aspect, the extra data channel may be useful for carrying out L2 control and management functions for WLAN systems. In another aspect, the extra data channel may be useful for carrying out L1 data (e.g., voice, locations, IoT data network controls, etc.).

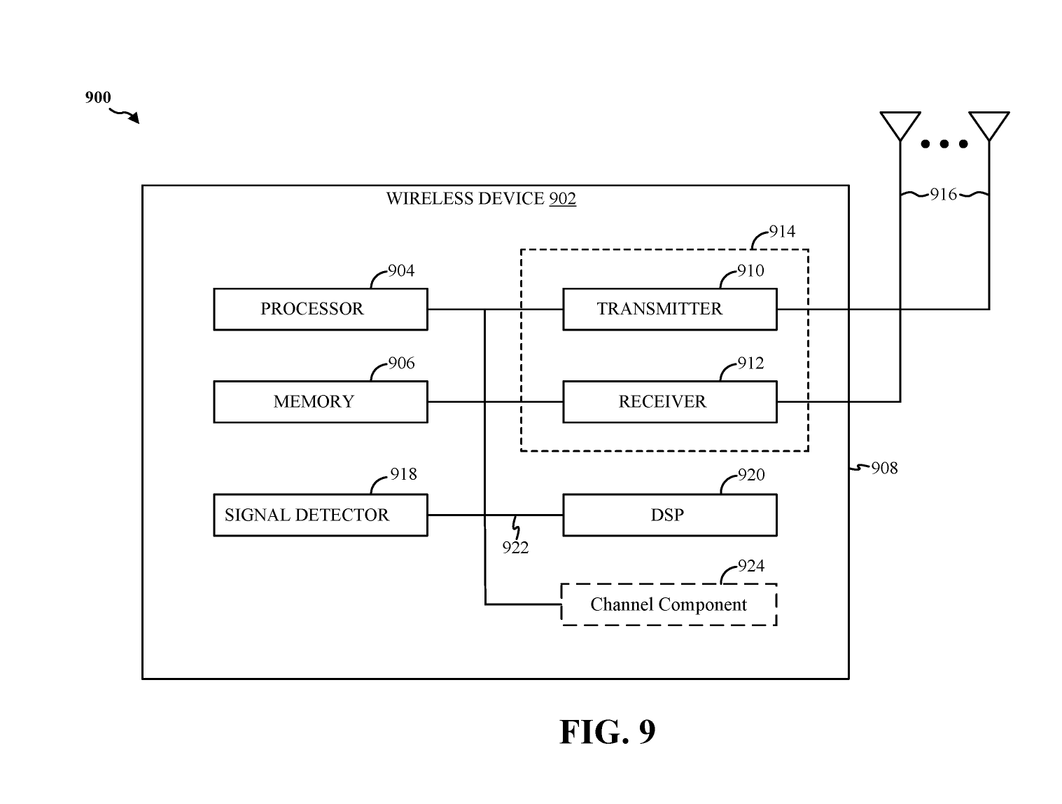

FIG. 9 shows an example functional block diagram of a wireless device 902 configured to transmit and receive information on a data channel. The wireless device 902 is an example of a device that may be configured to implement the various methods described herein. For example, the wireless device 902 may be the AP 110 and/or the UT 120.

The wireless device 902 may include a processor 904 which controls operation of the wireless device 902. The processor 904 may also be referred to as a central processing unit (CPU). Memory 906, which may include both read-only memory (ROM) and random access memory (RAM), may provide instructions and data to the processor 904. A portion of the memory 906 may also include non-volatile random access memory (NVRAM). The processor 904 typically performs logical and arithmetic operations based on program instructions stored within the memory 906. The instructions in the memory 906 may be executable (by the processor 904, for example) to implement the methods described herein.

The wireless device 902 may also include a housing 908, and the wireless device 902 may include a transmitter 910 and a receiver 912 to allow transmission and reception of data between the wireless device 902 and a remote device. The transmitter 910 and receiver 912 may be combined into a transceiver 914. A single transmit antenna or a plurality of transmit antennas 916 may be attached to the housing 908 and electrically coupled to the transceiver 914. The wireless device 902 may also include multiple transmitters, multiple receivers, and multiple transceivers.

The wireless device 902 may also include a signal detector 918 that may be used in an effort to detect and quantify the level of signals received by the transceiver 914 or the receiver 912. The signal detector 918 may detect such signals as total energy, energy per subcarrier per symbol, power spectral density and other signals. The wireless device 902 may also include a digital signal processor (DSP) 920 for use in processing signals. The DSP 920 may be configured to generate a packet for transmission. In some aspects, the packet may comprise a physical layer convergence procedure (PLCP) protocol data unit (PPDU).

The various components of the wireless device 902 may be coupled together by a bus system 922, which may include a power bus, a control signal bus, and a status signal bus in addition to a data bus.

In one configuration, when the wireless device 902 is implemented as an AP or a STA configured to transmit data on a data channel, the wireless device 902 may include a channel component 924. The channel component 924 may be configured map a data set based on a modulation scheme. The channel component 924 may be configured to modulate the mapped data set based on a set of codes, and the set of codes may be orthogonal to a portion of a frame. The channel component 924 may be configured to output the modulated data set for transmission. In an aspect, the portion of the frame may include segments with redundancy. In another aspect, the segments with redundancy may be associated with an LTF symbol of the frame, an STF symbol of the frame, and/or one or more cyclic prefixes associated with data symbols of the frame. In another configuration, the channel component 924 may be configured to modulate the mapped data set by identifying a subset of the set of codes (or code indices) in which a cross-correlation of the subset of the set of codes (or code indices) and the portion of the frame is zero and by modulating the mapped data set based on the subset of the set of codes. In this configuration, the set of codes may be Hadamard codes. In another configuration, the channel component 924 may be configured to map the data set, based on a type of QAM, to at least one QAM symbol. In an aspect, the channel component 924 may be configured to obtain one or more data packets from at least one wireless node, and the channel component 924 may be configured to generate the data set based on the received one or more data packets. In this configuration, the data set may include a pathloss and a device identifier associated with the at least one wireless node. In another configuration, the channel component 924 may be configured to generate the frame and to broadcast the frame. In another configuration, the channel component 924 may be configured to broadcast the frame with the modulated data set by adding the modulated data set to the portion of the frame based on a power factor. In an aspect, the power factor may be equal to or less than 0 decibels.

In another configuration, when the wireless device 902 is implemented as an AP or a STA configured to receive data on a data channel, the channel component 924 may be configured to obtain a frame from a second apparatus. The frame may include a portion having data encoded based on a set of codes, and the set of codes may be orthogonal to the portion of the frame. The channel component 924 may be configured to decode the encoded data. In one configuration, the channel component 924 may be configured to decode the encoded data by demodulating the encoded data within the portion of the frame based on the set of codes and by demapping demodulated data to obtain decoded data. In an aspect, the portion of the frame may include segments with redundancy. In another aspect, the segments with redundancy may be associated with an LTF symbol of the frame, an STF symbol of the frame, or a cyclic prefix associated with data symbols of the frame. In another aspect, the set of codes may correspond to Hadamard codes. In another aspect, the decoded data may include interference data comprising a pathloss and a device identifier. In another configuration, the channel component 924 may be configured to obtain additional frames from other apparatuses, and each of the additional frames may include additional interference data encoded based on the set of codes. In this configuration, the channel component 924 may be configured to decode the additional interference data from the additional frames and to generate an interference matrix based on the interference data and the decoded additional interference data. The interference matrix may include one or more pathloss values, and each of the one or more pathloss values may be associated with a transmitter identifier and a receiver identifier. In another configuration, the channel component 924 may be configured to determine whether to transmit data to a third apparatus based on the generated interference matrix. In an aspect, the channel component 924 may be configured to determine whether to transmit data by determining an amount of interference at the third apparatus based on the generated interference matrix, by identifying a set of transmission parameters for transmitting the data to the apparatus, and by calculating an expected signal quality at the third apparatus based on the determined amount of interference and the identified set of transmission parameters. In this aspect, the determination of whether to transmit the data may be based on the expected signal quality at the apparatus.

In general, an AP and STA may perform similar (e.g., symmetric or complementary) operations. Therefore, for many of the techniques described herein, an AP or STA may perform similar operations. To that end, the following description will sometimes refer to an “AP/STA” to reflect that an operation may be performed by either. Although, it should be understood that even if only “AP” or “STA” is used, it does not mean a corresponding operation or mechanism is limited to that type of device.

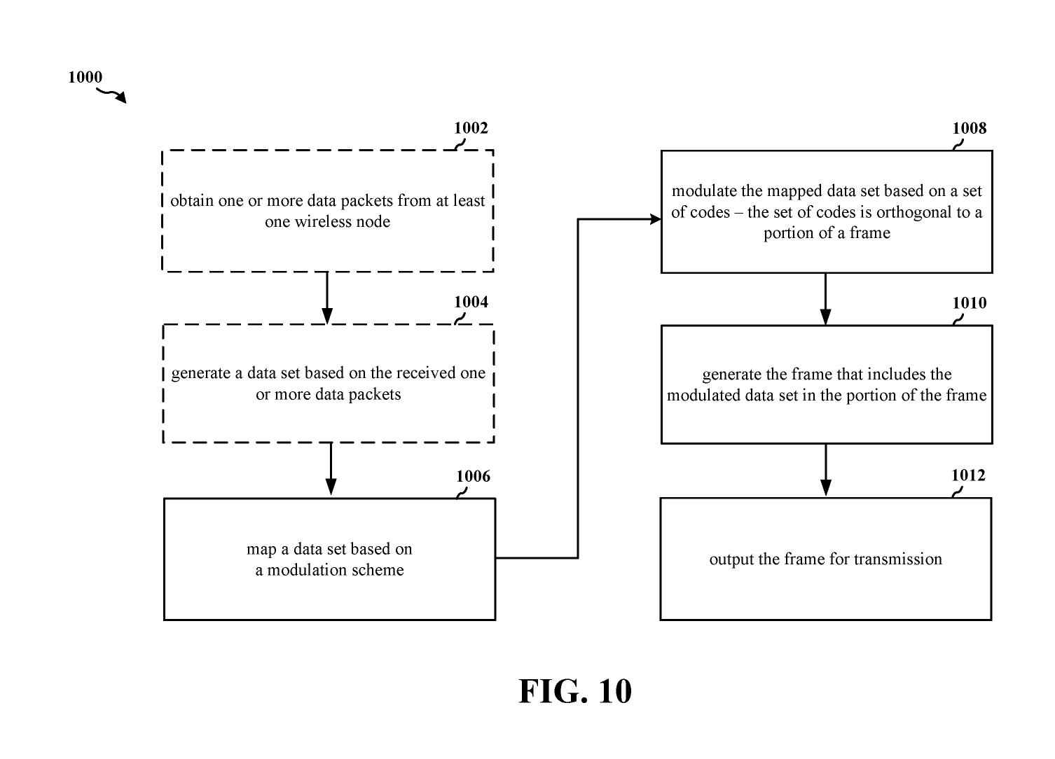

FIG. 10 is a flowchart of an example method 1000 of transmitting data on an extra data channel for wireless communication. The method 1000 may be performed using an apparatus (e.g., the AP 110, the UT 120, the channel component 924, or the wireless device 902, for example). Although the method 1000 is described below with respect to the elements of wireless device 902 of FIG. 9, other components may be used to implement one or more of the steps described herein. Blocks denoted by dotted lines may represent optional operations.

At block 1002, an apparatus may obtain one or more data packets from at least one wireless node. For example, referring to FIG. 4, the apparatus may correspond to the third wireless node 406. The third wireless node 406 may obtain one or more data packets from the first, second, and fourth wireless nodes 402, 404, 408.

At block 1004, the apparatus may generate a data set based on the received one or more data packets. For example, referring to FIG. 4, the third wireless node 406 may generate interference information based on the received one or more data packets. The third wireless node 406 may generate the interference information by determining a pathloss associated with each of the transmissions from the first, second, and fourth wireless nodes 402, 404, 408. The interference information may further include a transmitter identifier and a receiver identifier (e.g., a full or partial MAC address) associated with each pathloss value.

At block 1006, the apparatus may map a data set based on a modulation scheme. For example, referring to FIG. 4, the third wireless node 406 may map the data set by determining a type of QAM for mapping the data set to QAM symbols. The third wireless node 406 may determine one or more amplitude and angle pairs based on the QAM mapping. For example, one or more bits in the data set may be mapped to a single amplitude and angle pair (or QAM symbol).

At block 1008, the apparatus may modulate the mapped data set based on a set of codes. The set of codes may be orthogonal to a portion of a frame. In an aspect, the portion of the frame may include segments with redundancy. The segments with redundancy may be associated with at least one of an LTF symbol of the frame, an STF symbol of the frame, and/or one or more cyclic prefixes associated with data symbols of the frame. For example, referring to FIG. 4, the third wireless node 406 may modulate the mapped data set based on a set of Hadamard codes. The third wireless node 406 may identify a subset of Hadamard codes in which a cross-correlation (or dot product) of the subset of the set of Hadamard codes and the portion of the frame is zero. The third wireless node 406 may modulate the mapped data set based on the subset of the set of codes.

At block 1010, the apparatus may generate the frame that includes the modulated data set in the portion of the frame. For example, referring to FIG. 4, the third wireless node 406 may generate the frame by identifying the portion of the frame that is orthogonal to the set of codes and by adding the modulated data set to the portion of frame. In an aspect, the modulated data set may be added to the portion of the frame based on a power factor. The power factor may be equal to or less than 0 decibels. Equal to may refer to exactly equal to or substantially equal to. In an example, the power factor may be −24 dB. The portion of the frame may be part of an LTF symbol and/or an STF symbol. In another configuration, the frame may be generated by including other data for transmission and by including information indicating the length of the frame. Subsequently, the modulated data set may be added to the frame for transmission.

At block 1012, the apparatus may output the frame for transmission. For example, referring to FIG. 4, the third wireless node 406 may output the frame for transmission.

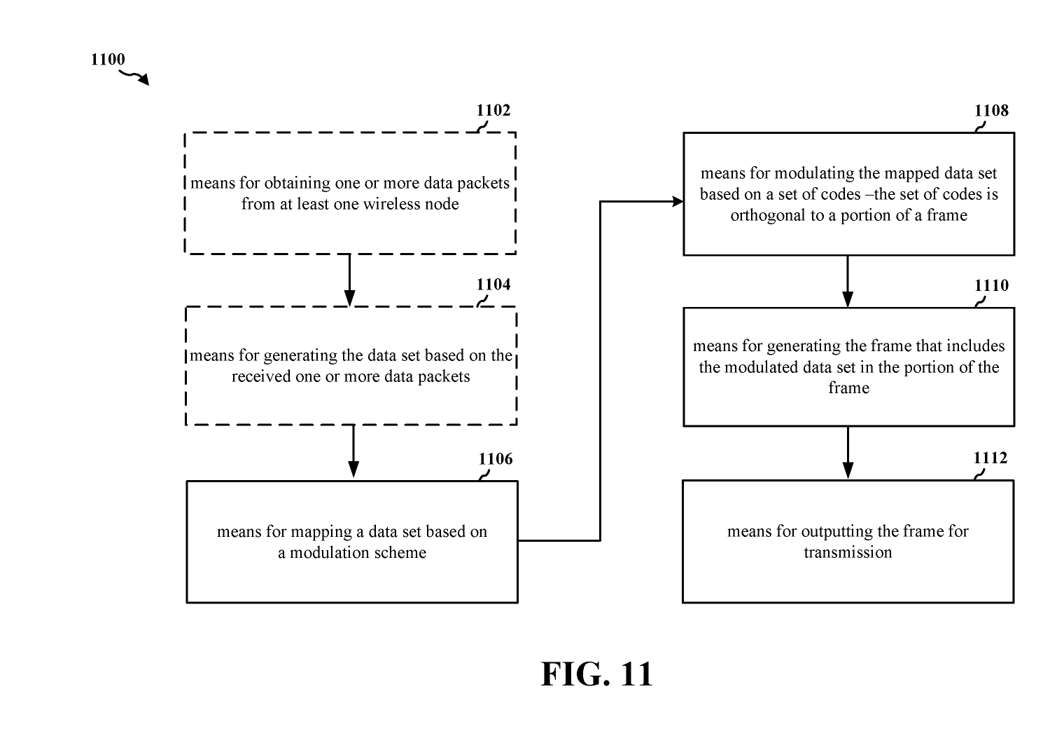

FIG. 11 illustrates exemplary means 1100 capable of performing the operations set forth in FIG. 10. The exemplary means 1100 may include means 1102 for obtaining one or more data packets from at least one wireless node. Means 1102 may include, for example, antennas 224, antennas 252, receiver units 222, receiver units 254, RX spatial processor 240, RX spatial processors 260, RX data processor 242, RX data processors 270, controller 230, controllers 280, antennas 916, receiver 912, digital signal processor 920, and/or processor 904 shown in FIG. 2 and FIG. 9. The exemplary means 1100 may include means 1104 for generating the data set based on the received one or more data packets. Means 1104 may include, for example, RX data processor 242, RX data processors 270, controller 230, controllers 280, receiver 912, digital signal processor 920, and/or processor 904 shown in FIG. 2 and FIG. 9. The exemplary means 1100 may include means 1106 for mapping a data set based on a modulation scheme. Means 1106 may include, for example, controller 230, controllers 280, digital signal processor 920, and/or processor 904 shown in FIG. 2 and FIG. 9. The exemplary means 1100 may include means 1108 for modulating the mapped data set based on a set of codes. Means 1108 may include, for example, antennas 224, antennas 252, transmitter units 222, transmitter units 254, TX spatial processor 220, TX spatial processors 290, TX data processor 210, TX data processors 288, controller 230, controllers 280, antennas 916, transmitter 910, digital signal processor 920, and/or processor 904 shown in FIG. 2 and FIG. 9. The exemplary means 1100 may include means 1110 for generating the frame that includes the modulated data set in the portion of the frame. Means 1110 may include, for example, controller 230, controllers 280, digital signal processor 920, and/or processor 904 shown in FIG. 2 and FIG. 9. The exemplary means 1100 may include means 1112 for outputting the frame for transmission. Means 1112 may include, for example, an interface (e.g., of a processor), antennas 224, antennas 252, transmitter units 222, transmitter units 254, TX spatial processor 220, TX spatial processors 290, TX data processor 210, TX data processors 288, controller 230, controllers 280, antennas 916, transmitter 910, digital signal processor 920, and/or processor 904 shown in FIG. 2 and FIG. 9.

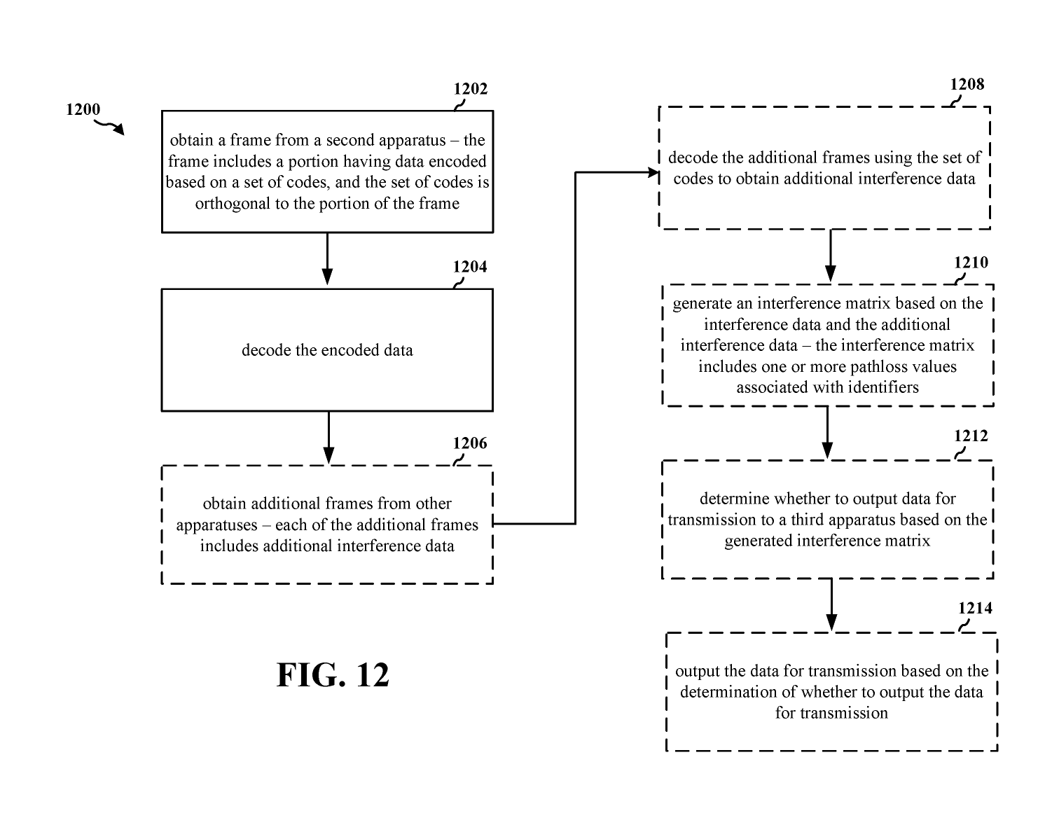

FIG. 12 is a flowchart of an example method 1200 of receiving data on an extra data channel for wireless communication. The method 1200 may be performed using an apparatus (e.g., the AP 110, the UT 120, the channel component 924, or the wireless device 902, for example). Although the method 1200 is described below with respect to the elements of wireless device 902 of FIG. 9, other components may be used to implement one or more of the steps described herein. Blocks denoted by dotted lines may represent optional operations.

At block 1202, an apparatus may obtain a frame from a second apparatus. The frame may include a portion having data encoded based on a set of codes, and the set of codes may be orthogonal to the portion of the frame. In an aspect, the portion of the frame may include segments with redundancy. The segments with redundancy may include at least one of an LTF symbol, an STF symbol, and/or cyclic prefixes associated with data symbols of the frame. In another aspect, the set of codes may be Hadamard codes. For example, referring to FIG. 4, the apparatus may correspond to the first wireless node 402, and the first wireless node 402 may obtain the first frame 410 (and/or the second and third frames 412, 414) from the third wireless node 406. The first frame 410 may include a portion with interference information encoded based on Hadamard codes that are orthogonal to the portion of the frame. The portion of the frame may include parts of an LTF and/or may include cyclic prefixes.

At block 1204, the apparatus may decode the encoded data. In one configuration, the apparatus may decode the encoded data by demodulating the encoded data within the portion of the frame based on the set of codes and by demapping the demodulated data to obtain decoded data. For example, referring to FIG. 4, the first wireless node 402 may decode the encoded interference information in the first frame 410 (and optionally in the second and third frames 412, 414). The first wireless node 402 may decode the interference information by demodulating the encoded data within the LTF of the frame based on a subset of Hadamard codes and by demapping the demodulated data to obtain the interference information. The interference information may include a pathloss and a transmitter MAC address and a receiver MAC address associated with the pathloss.

At block 1206, the apparatus may obtain additional frames from other apparatuses. Each of the additional frames may include additional interference data encoded based on the set of codes. For example, referring to FIG. 4, the first wireless node 402 may obtain additional frames from the second and fourth wireless nodes 404, 408.

At block 1208, the apparatus may decode the additional frames to obtain additional interference data. For example, referring to FIG. 4, the first wireless node 402 may decode the additional frames to obtain the additional interference data based on the techniques as discussed.

At block 1210, the apparatus may generate an interference matrix based on the interference data and the decoded additional interference data. The interference matrix may include one or more pathloss values associated with identifiers. For example, referring to FIG. 4, the first wireless node 402 may generate the interference matrix 420 based on the interference data from the third wireless node 406 (e.g., based on the first, second, and third frames 410, 412, 414) and from the decoded additional interference data from the second and fourth wireless nodes 404, 408.

At block 1212, the apparatus may determine whether to output data for transmission to a third apparatus based on the generated interference matrix. The apparatus may determine whether to output data for transmission by determining an amount of interference at the third apparatus based on the generated interference matrix, by identifying a set of transmission parameters to be used for transmitting the data to the apparatus, and by calculating an expected signal quality at the third apparatus based on the determined amount of interference and the identified set of transmission parameters. The determination of whether to transmit the data may be based on the expected signal quality at the apparatus. For example, referring to FIG. 4, the first wireless node 402 may determine whether to send the first transmission 418 to the second wireless node 404 based on the interference matrix 420. The first wireless node 402 may determine whether to send the first transmission 418 by determining an amount of interference at the second wireless node 404 based on the interference matrix 420 due to the second transmission 416 and by identifying a set of transmission parameters for transmitting the first transmission 418. The set of transmission parameters may include an MCS, a transmission power, a bandwidth, and/or a number of spatial streams. Based on the set of transmission parameters, the amount of interference at the second wireless node 404, and the pathloss between the first and second wireless nodes 402, 404, the first wireless node 402 may calculate an expected signal quality (e.g., SINR) at the second wireless node 404. If the expected signal quality is equal to or above a threshold, then the first wireless node 402 may determine to send the first transmission 418. However, if the expected signal quality is less than the threshold, then the first wireless node 402 may determine to refrain from sending the first transmission 418.

At block 1214, the apparatus may output the data for transmission based on the determination of whether to output the data for transmission. For example, referring to FIG. 4, the first wireless node 402 may output the data for transmission.

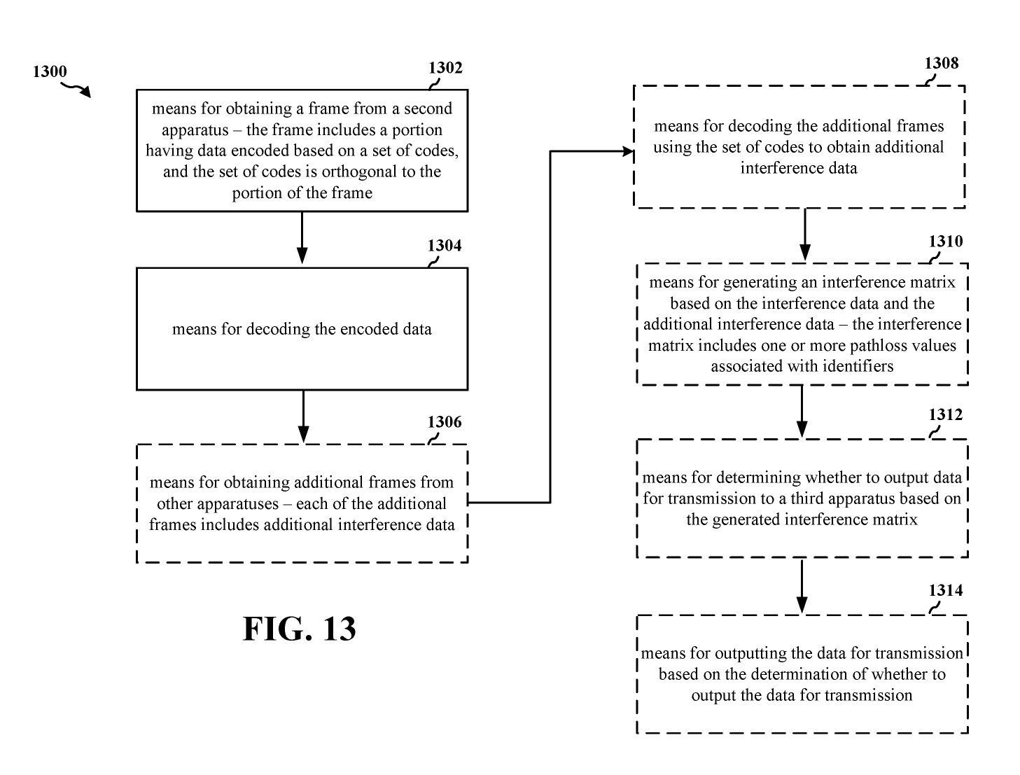

FIG. 13 illustrates exemplary means 1300 capable of performing the operations set forth in FIG. 12. The exemplary means 1300 may include means 1302 for obtaining a frame from a second apparatus. Means 1302 may include, for example, antennas 224, antennas 252, receiver units 222, receiver units 254, RX spatial processor 240, RX spatial processors 260, RX data processor 242, RX data processors 270, controller 230, controllers 280, antennas 916, receiver 912, digital signal processor 920, and/or processor 904 shown in FIG. 2 and FIG. 9. The exemplary means 1300 may include means 1304 for decoding the encoded data. The means 1304 may include, for example, RX spatial processor 240, RX spatial processors 260, RX data processor 242, RX data processors 270, controller 230, controllers 280, digital signal processor 920, and/or processor 904 shown in FIG. 2 and FIG. 9. The exemplary means 1300 may include means 1306 for obtaining additional frames from other apparatuses. Means 1306 may include, for example, antennas 224, antennas 252, receiver units 222, receiver units 254, RX spatial processor 240, RX spatial processors 260, RX data processor 242, RX data processors 270, controller 230, controllers 280, antennas 916, receiver 912, digital signal processor 920, and/or processor 904 shown in FIG. 2 and FIG. 9. The exemplary means 1300 may include means 1308 for decoding the additional frames using the set of codes to obtain additional interference data. Means 1308 may include, for example, RX spatial processor 240, RX spatial processors 260, RX data processor 242, RX data processors 270, controller 230, controllers 280, antennas 916, receiver 912, digital signal processor 920, and/or processor 904 shown in FIG. 2 and FIG. 9. The exemplary means 1300 may include means 1310 for generating an interference matrix based on the interference data and the decoded additional interference data. Means 1310 may include, for example, RX data processor 242, RX data processors 270, controller 230, controllers 280, antennas 916, receiver 912, digital signal processor 920, and/or processor 904 shown in FIG. 2 and FIG. 9. The exemplary means 130 may include means 1312 for determining whether to output data for transmission to a third apparatus based on the generated interference matrix. Means 1312 may include, for example, TX data processor 210, TX data processors 288, controller 230, controllers 280, transmitter 910, digital signal processor 920, and/or processor 904 shown in FIG. 2 and FIG. 9. The exemplary means 130 may include means 1314 for outputting the data for transmission based on the determination of whether to output the data for transmission. Means 1314 may include, for example, TX data processor 210, TX data processors 288, controller 230, controllers 280, transmitter 910, digital signal processor 920, and/or processor 904 shown in FIG. 2 and FIG. 9.

The various operations of methods described above may be performed by any suitable means capable of performing the operations. The means may include various hardware and/or software component(s) and/or module(s), including, but not limited to a circuit, an application specific integrated circuit (ASIC), or processor. Generally, any operations illustrated in the Figures may be performed by corresponding functional means capable of performing the operations.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, the term receiver may refer to an RF receiver (e.g., of an RF front end) or an interface (e.g., of a processor) for receiving structures processed by an RF front end (e.g., via a bus). Similarly, the term transmitter may refer to an RF transmitter of an RF front end or an interface (e.g., of a processor) for outputting structures to an RF front end for transmission (e.g., via a bus).

As used herein, a phrase referring to “at least one of” a list of items refers to any combination of those items, including single members. As an example, “at least one of: a, b, or c” is intended to cover a, b, c, a-b, a-c, b-c, a-b-c, a-a, b-b, and c-c.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
a processing system configured to:
map a data set based on a modulation scheme,
modulate the mapped data set based on a set of codes, the set of codes being orthogonal to a portion of a frame, and
generate the frame comprising the modulated data set in the portion of the frame; and
an interface configured to output the frame for transmission.

2. The apparatus of claim 1, wherein the portion of the frame includes segments with redundancy.

3. The apparatus of claim 2, wherein the segments with redundancy are associated with at least one of a long training field (LTF) symbol of the frame, a short training field (STF) symbol of the frame, or a cyclic prefix associated with data symbols of the frame.

4. The apparatus of claim 1, wherein the processing system is configured to modulate the mapped data set by:
identifying a subset of the set of codes in which a cross-correlation of the subset of the set of codes and the portion of the frame is zero; and
modulating the mapped data set based on the subset of the set of codes.

5. The apparatus of claim 1, wherein the set of codes comprises Hadamard codes.

6. The apparatus of claim 1, wherein the data set is mapped, based on a type of quadrature amplitude modulation (QAM), to at least one QAM symbol.

7. The apparatus of claim 1, wherein the interface is further configured to obtain one or more data packets from at least one wireless node, and the processing system is further configured to generate the data set based on the received one or more data packets.

8. The apparatus of claim 7, wherein the data set includes a pathloss and a device identifier associated with the at least one wireless node.

9. The apparatus of claim 1, wherein the frame generation comprises adding the modulated data set to the portion of the frame based on a power factor.

10. The apparatus of claim 9, wherein the power factor is equal to or less than 0 decibels.

11. An apparatus for wireless communication, comprising:
an interface configured to obtain a frame from a second apparatus, wherein the frame comprises a portion having data encoded based on a set of codes, and wherein the set of codes is orthogonal to the portion of the frame; and
a processing system configured to decode the encoded data.

12. The apparatus of claim 11, wherein the processing system is configured to decode the encoded data by:
demodulating the encoded data within the portion of the frame based on the set of codes; and
demapping the demodulated data to obtain decoded data.

13. The apparatus of claim 11, wherein the set of codes comprises Hadamard codes.

14. The apparatus of claim 11, wherein decoded data includes interference data comprising a pathloss and a device identifier.

15. The apparatus of claim 14, wherein the interface is further configured to obtain additional frames from other apparatuses, and wherein the processing system is further configured to:
decode the additional frames using the set of codes to obtain additional interference data; and
generate an interference matrix based on the interference data and the additional interference data, wherein the interference matrix comprises one or more pathloss values, and each of the one or more pathloss values is associated with a transmitter identifier and a receiver identifier.

16. The apparatus of claim 15, wherein the processing system is further configured to determine whether to output the data for transmission to a third apparatus based on the generated interference matrix, and wherein the interface is further configured to output the data for transmission based on the determination of whether to output the data for transmission.

17. The apparatus of claim 16, wherein the processing system determines whether to output data for transmission by:
determining an amount of interference at the third apparatus based on the generated interference matrix;
identifying a set of transmission parameters to be used for transmitting the data to the third apparatus; and
calculating an expected signal quality at the third apparatus based on the determined amount of interference and the identified set of transmission parameters, wherein the determination of whether to output the data for transmission is based on the expected signal quality at the third apparatus, and wherein the data is outputted based on the expected signal quality at the third apparatus.

18-53. (canceled)

54. A wireless node for wireless communication, comprising:
a processing system configured to:
map a data set based on a modulation scheme,
modulate the mapped data set based on a set of codes, the set of codes being orthogonal to a portion of a frame, and
generate the frame comprising the modulated data set in the portion of the frame; and
a transmitter configured to transmit the frame.

55. (canceled)
